(19) United States
(12) Patent Application Publication
(10) Pub. No.: US 2018/0289569 A1
(43) Pub. Date: Oct. 11, 2018

(54) BED DEVICE, MATTRESS AND EXCRETA RECOVERY DEVICE

(71) Applicant: HFJ Life Business Co., Ltd., Saitama (JP)

(72) Inventors: Fujio HARA, Gyoda-shi, Saitama (JP); Chun-Yuan HSIAO, Gyoda-shi, Saitama (JP); Shao-Chi CHANG, Gyoda-shi, Saitama (JP)

(21) Appl. No.: 15/575,393

(22) PCT Filed: Feb. 27, 2017
(86) PCT No.: PCT/JP2017/007421

§ 371 Date: Nov. 20, 2017

(51) Int. Cl. A61G 7/02; A61G 7/015

(52) U.S. Cl. CPC A61G 7/02; A61G 7/015

(57) ABSTRACT

A bed device has a bed body having a frame part and a mattress laid on the frame part, and an excreta treatment unit located below the mattress. The mattress has a through hole at a section corresponding to buttocks of a user. The excreta treatment unit has an excreta recovery unit attached to the through hole, an excreta storage unit configured to store excreta recovered at the excreta recovery unit, and a cleaning unit attached to the excreta recovery unit for jetting washing water upward via the through hole. The excreta recovery unit has a cup fitted to the through hole, a recovery pipe provided between the cup and the excreta storage unit, and a convex part extending upward from an edge of the cup to be inserted between the buttocks.

### TECHNICAL FIELD

The present invention relates to a bed device, a mattress and an excreta recovery device.

### BACKGROUND ART

In a case where a person with physical disability due to advanced age, injury, illness or the like uses a bed, defecation or urination is often treated (excreta treatment) while he is lying on the bed. Patent Documents 1 to 3 disclose nursing care beds as techniques for facilitating excreta treatment while lying on a bed. These nursing care beds are each provided with a tank configured to accumulate excreta below a bed body, so that excreta can be accumulated in the tank placed at a lower position through a hole formed at a bed part.

Patent Documents 4 to 7 disclose wearable excreta treatment devices. Regarding such a device, a patient or a care giver wears the device at his waist part, so that it is possible to recover excreta using the device without requiring the patient to get up from the bed. Moreover, the worn device is constructed to jet warm water or the like to clean the anus or the like, or to dry the anus or the like with warm air or the like.

Patent Documents 8 and 9 disclose nursing care mats (mattresses). Such a mattress is provided with a hole at a central part. A pipe or the like is put through the hole toward an excreta recovery device provided below the bed body.

### PRIOR ART REFERENCES

### Patent Document

Patent Document 1: JP 2016-172056 A
Patent Document 2: JP 2012-503520 A
Patent Document 3: JP 2009-045151 A
Patent Document 4: JP 2013-085827 A
Patent Document 5: JP 2001-079028 A
Patent Document 6: JP 2007-330760 A
Patent Document 7: JP 2008-237420 A
Patent Document 8: JP 2017-000371 A
Patent Document 9: JP 2007-319335 A

### SUMMARY OF THE INVENTION

### Problems to be Solved by the Invention

Since excreta treatment needs to be performed regularly, it is desired in the nursing care field to reduce the burden on both of a person who receives nursing care and a person who gives nursing care. Moreover, it is desired to perform excreta treatment privately, and therefore it is preferable to individually prepare a system configured to perform excreta treatment without requiring the user to get off from a bed. Therefore, a structure which can be installed compactly for each bed is needed rather than large-scale equipment. Maintainability is also important, since the device is used every day.

The object of the present invention is to provide a bed device, a mattress and an excreta recovery device, which can be located under a bed, can recover excreta easily and reliably, and are excellent in maintainability.

### Means for Solving the Problems

With the aim of solving the above problems, an aspect of the present invention is a bed device provided with: a bed body having a frame part and a mattress laid on the frame part; and an excreta treatment unit located below the mattress of the bed body.

The mattress has: a first section corresponding to the back; a second section, which corresponds to the buttocks and is provided with a through hole; a third section corresponding to the above-knee region; and a fourth section corresponding to the below-knee region.

The frame part has: a first supporting section configured to support the first section of the mattress and adjust the angle of the first section; a second supporting section configured to support the second section of the mattress; a third supporting section configured to support the third section of the mattress and adjust the angle of the third section; and a fourth supporting section configured to support the fourth section of the mattress and adjust the angle of the fourth section.

The excreta treatment unit has: an excreta recovery unit, which is attached to the through hole provided at the second section of the mattress; an excreta storage unit configured to store excreta recovered at the excreta recovery unit; and a cleaning unit, which is attached to the excreta recovery unit and jets washing water upward via the through hole.

The excreta recovery unit has: a cup fitted to the through hole provided at the second section of the mattress; a recovery pipe provided between the cup and the excreta storage unit; and a convex part, which is provided to be extended upward from an edge of the cup and is inserted between the right and left buttocks of a user.

With such a structure, the user can treat excreta without getting off from the bed body. When the user excretes, for example, excreta is recovered by the excreta recovery unit attached to the through hole provided at the second section of the mattress, and an excreta is transferred to the excreta treatment unit provided below the bed body.

It is possible to raise the body of the user to an angle with which it is easy to excrete, by causing the first supporting section and the third supporting section of the frame part to tilt as required.

Moreover, since the convex part extended upward from an edge of the cup is inserted between the right and left buttocks of the user, it is possible to keep the right and left buttocks open moderately and to recover excreta without being obstructed by the buttocks.

The above bed device may be provided so that an angle of the third supporting section with respect to the first supporting section becomes smaller than 90 degrees when the first supporting section and the third supporting section are caused to tilt. This allows the user to take a posture of bending his above-knee region and thrusting his buttocks while raising his back. It is easy with this posture to excrete.

An aspect of the present invention is a mattress to be laid on a frame part of a bed body. The mattress has: a first section corresponding to the back; a second section, which corresponds to the buttocks and is provided with a through hole to which an excreta treatment device is to be attached; a third section corresponding to the above-knee region; and a fourth section corresponding to the below-knee region.

The first section is provided with: a lower section; an upper section provided separately from the lower section; and a sliding mechanism configured to slide the upper section with respect to the lower section.

It is possible with such a structure to attach an excreta treatment device to the through hole provided at the second section and to recover excreta via the through hole. Moreover, since the upper section of the first section is provided to be able to slide with respect to the lower section, the buttocks or the like are kept from being caught in a border between the first section and the second section when the first section is raised, and it is possible to reduce uncomfortable feeling of the user.

An aspect of the present invention is an excreta recovery device to be located below a mattress laid on a frame part of a bed body. The excreta recovery device is provided with: a cup to be fitted to a through hole provided at the mattress; a recovery pipe connected with the cup; and a convex part, which is provided to be extended upward from an edge of the cup and is inserted between the right and left buttocks of the user.

It is possible with such a structure to receive excreta with the cup, which is fitted to the through hole provided at the mattress, and to transfer the excreta to the recovery pipe when the user excretes. Since the convex part extended upward from an edge of the cup is inserted between the right and left buttocks of the user in this process, it is possible to keep the right and left buttocks open moderately and to recover excreta without being obstructed by the buttocks.

### BRIEF DESCRIPTION OF THE DRAWINGS

FIG. 1 is a perspective view illustrating a bed device according to this embodiment.

FIGS. 2A and 2B are schematic drawings illustrating a mattress according to this embodiment.

FIGS. 3A and 3B are schematic drawings illustrating an excreta recovery unit.

FIGS. 4A and 4B are schematic cross sections illustrating a valve provided in the middle of a recovery pipe.

FIG. 5 is a perspective view illustrating an excreta recovery unit.

FIG. 6 is a schematic drawing illustrating the positional relationship between the user and a cup.

FIGS. 7A and 7B are schematic drawings illustrating a first section of the mattress.

FIG. 8 is a schematic drawing illustrating excreta treatment.

FIG. 9 is a schematic drawing illustrating the angle of the mattress.

### DESCRIPTION OF EMBODIMENTS

The following description will explain an embodiment of the present invention with reference to the drawings. It is to be noted that identical codes are used to denote identical members in the following description, and explanation on a member which has been described is suitably omitted.

(Bed Device)

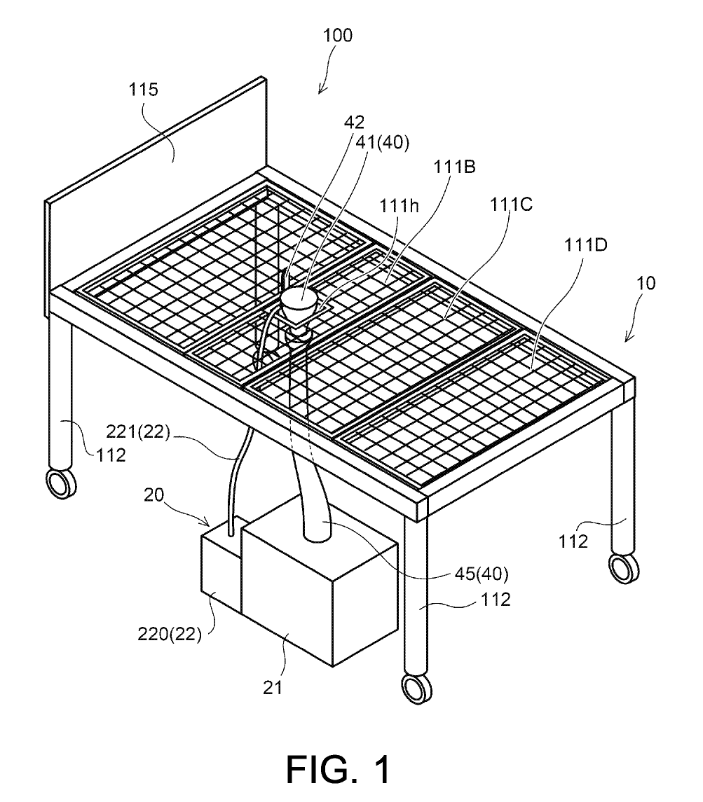

FIG. 1 is a perspective view illustrating a bed device according to this embodiment.

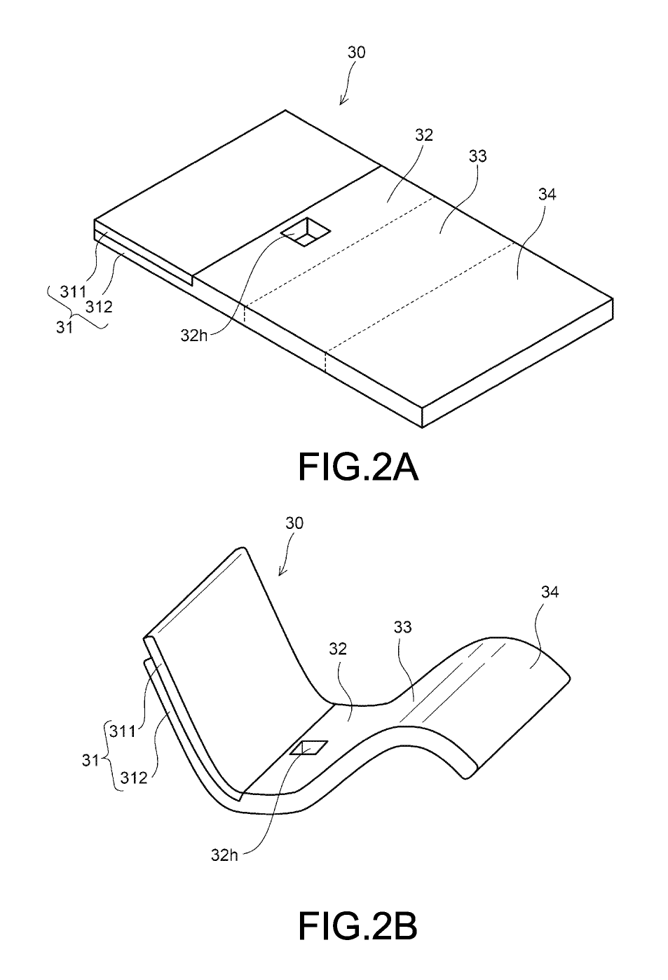

FIGS. 2A and 2B are schematic drawings illustrating a mattress according to this embodiment. FIG. 2A illustrates a perspective view of a mattress 30, and FIG. 2B illustrates a state where the mattress 30 is bent.

It is to be noted that a bed device 100 includes the mattress 30, though the mattress 30 is not illustrated in FIG. 1 for convenience of explanation.

The bed device 100 according to this embodiment is provided with a bed body 10 and an excreta treatment unit 20. The bed body 10 has: a frame part 11 with a rectangular outer frame 111; and the mattress 30 laid on the frame part 11. The outer frame 111 of the frame part 11 is assembled to have a rectangular shape, and a leg part 12 extended downward is attached to each of the four corners of the outer frame 111. Moreover, a head board 115 is provided at an end of the outer frame 111 as required.

Provided inside the outer frame 111 are a first supporting section 111A, a second supporting section 111B, a third supporting section 111C and a fourth supporting section 111D. The mattress 30 is laid on these supporting sections 111A to 111D, and the supporting sections 111A to 111D support the mattress 30 from below.

The mattress 30 has: a first section 31 corresponding to the back part of the user; a second section 32 corresponding to the buttocks of the user; a third section 33 corresponding to the above-knee region of the user; and a fourth section 34 corresponding to the below-knee region of the user. The mattress 30 is constructed to be easily bent at the respective borders between these parts 31 to 34.

When the mattress 30 is laid on the frame part 11, a positional relationship is formed wherein the first supporting section 111A of the frame part 11 supports the first section 31 of the mattress 30, the second supporting section 111B of the frame part 11 supports the second section 32 of the mattress 30, the third supporting section 111C of the frame part 11 supports the third section 33 of the mattress 30, and the fourth supporting section 111D of the frame part 11 supports the fourth section 34 of the mattress 30.

The first supporting section 111A of the frame part 11 can adjust the angle of the first section 31 of the mattress 30. The third supporting section 111C can adjust the angle of the third section 33 of the mattress 30. Moreover, the fourth supporting section 111D can adjust the angle of the fourth section 34 of the mattress 30. It is to be noted that the second supporting section 111B is fixed to the outer frame 111, so that angle adjustment is not performed.

The respective angles of the first supporting section 111A, the third supporting section 111C and the fourth supporting section 111D are caused by a drive mechanism (e.g., an electric motor and a link mechanism), which is not illustrated in the figures, to tilt from a horizontal position to a predetermined angle. Moreover, a link mechanism enables parallel translation in addition to such angle adjustment.

The respective angles of the first supporting section 111A, the third supporting section 111C and the fourth supporting section 111D may be adjusted in conjunction with each other, or may be adjusted independently. In this embodiment, the angle of the first supporting section 111A can be adjusted independently, while the angles of the third supporting section 111C and the fourth supporting section 111D can be adjusted in conjunction with each other.

The mattress 30 is laid on such a frame part 11, and whole of the mattress 30 becomes horizontal when the first supporting section 111A, the third supporting section 111C and the fourth supporting section 111D are made horizontal. This allows the user to lie horizontally.

On the other hand, when the first supporting section 111A, the third supporting section 111C and the fourth supporting section 111D are caused to tilt, the first section 31, the third section 33 and the fourth section 34 of the mattress 30 also tilt likewise. The tilt of the first section 31, the third section 33 and the fourth section 34 of the mattress 30 allows the user to raise the body or to take a posture of sitting up.

When the first supporting section 111A is caused to tilt, for example, the first section 31 corresponding to the back of the mattress 30 rises, so as to raise the back of the user. Moreover, when the third supporting section 111C and the fourth supporting section 111D are caused to tilt so as to form an inverted V shape, the third section 33 and the fourth section 34 of the mattress 30 bend to form an inverted V shape, so as to lift the knees of the user. FIG. 2B illustrates an example of a tilt state of the mattress 30.

A through hole 32h is provided at the second section 32 of the mattress 30. Moreover, a hole 111h is provided at the second supporting section 111B, which supports the second section 32, of the frame part 11 in correspondence with the through hole 32h. When the mattress 30 is laid on the frame part 11, the through hole 32h of the second section 32 fits the hole 111h of the second supporting section 111B positioned below. Excreta of the user can be transferred to an excreta treatment unit 20, which is located below the bed body 10, via the through hole 32h and the hole 111h.

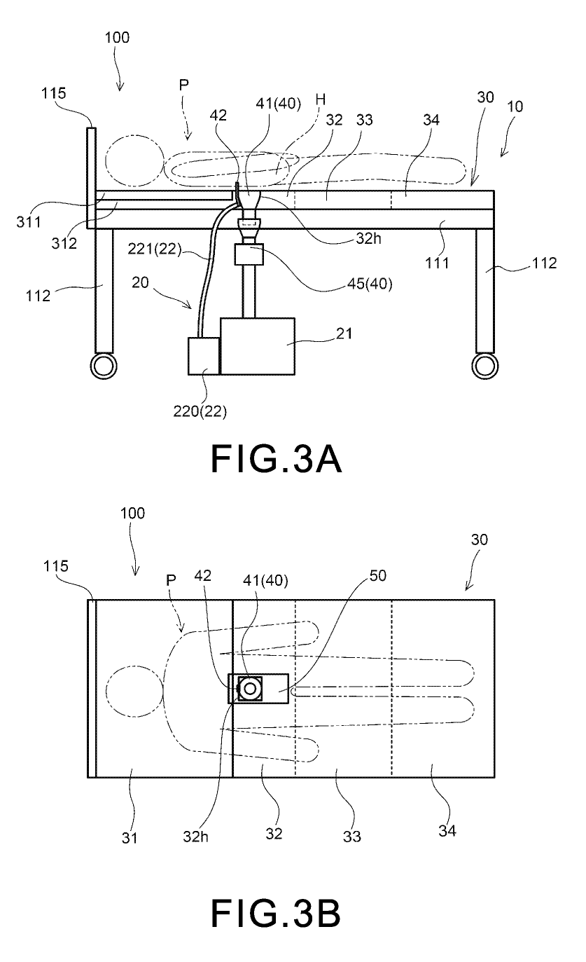

FIGS. 3A and 3B are schematic drawings illustrating the excreta recovery unit.

FIG. 3A illustrates a schematic drawing of the bed body 10 viewed from one side, and FIG. 3B illustrates a schematic drawing of the bed body 10 viewed from the top.

The excreta treatment unit 20 has: an excreta recovery unit 40 to be attached to the through hole 32h; an excreta storage unit 21 configured to store excreta recovered at the excreta recovery unit 40; and a cleaning unit 22, which is attached to the excreta recovery unit 40 and jets washing water upward via the through hole 32h.

The excreta recovery unit 40 has: a cup 41 to be fitted to the through hole 32h of the mattress 30; and a recovery pipe 45 connected with the cup 41. The cup 41 and the recovery pipe 45 are separated from each other, and a pipe extended downward from the cup 41 is put into the recovery pipe 45 from the upper end part thereof. The cup 41 is attached to a diaper cover 500 to be worn by the user P. With such a structure, the cup 41 can be placed at the position of the buttocks H of the user when the user P wears the diaper cover.

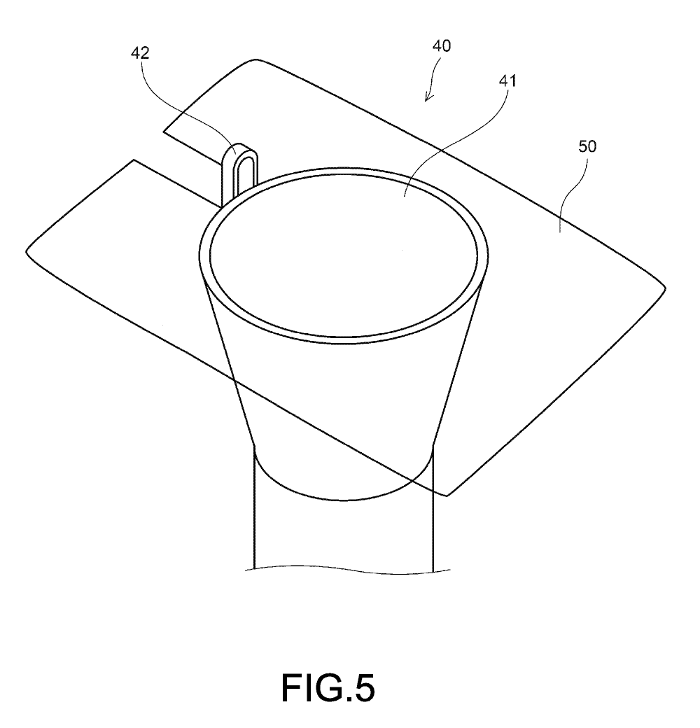

The cleaning unit 22 has: a washing water tank 220 configured to accumulate washing water; and a water supply hose 221 configured to supply washing water from the washing water tank 220 to the position of the cup 41. The tip of the water supply hose 221 is put into the middle of the cup 41, so that washing water can be jetted to the buttocks H. Washing water may be heated at the washing water tank 220 and converted into warm water. Moreover, an air supply hose 222 for supplying air or warm air may be put into the middle of the cup 41 (see FIG. 5) in parallel with the water supply hose 221. The buttocks H wetted by washing water is dried by blowing air or warm air against the buttocks H after cleaning process.

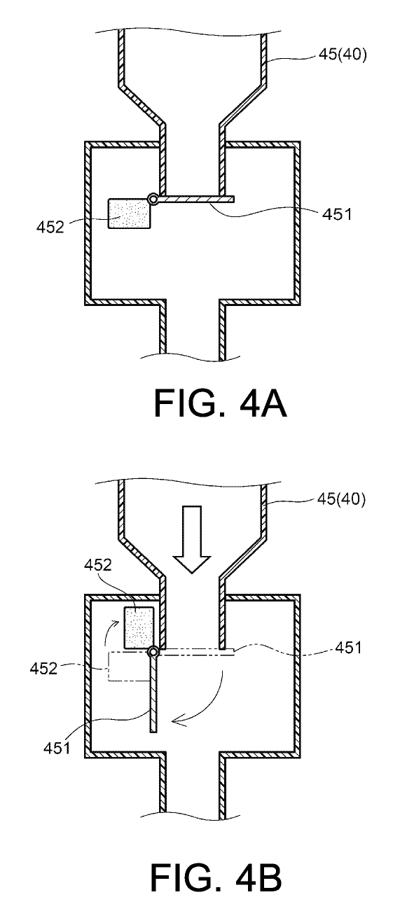

FIGS. 4B and 4B are schematic cross sections illustrating a valve provided in the middle of the recovery pipe.

A valve 451 is provided in the middle of the recovery pipe 45. The valve 451 is closed by the action of a weight 452 in a normal state as illustrated in FIG. 4A. When the valve 451 is closed, it is possible to stop the smell generated from excreta accumulated in the excreta storage unit 21.

When the user P excretes, the weight of the excreta causes the valve 451 to open as illustrated in FIG. 4B, so that the excreta is transferred from the recovery pipe 45 to the excreta storage unit 21. The valve 451 is constructed to close again by the action of the weight 452 after the excreta is transferred.

Here, the motion of the weight 452 or the open/close state of the valve 451 may be detected by a sensor (e.g., a limit switch, a photoelectronic sensor or the like), and control may be performed so that washing water is jetted from the water supply hose 221, or air or hot air is blown from the air supply hose 222, when it is detected that the valve 451 has opened.

(Excreta Recovery Unit)

FIG. 5 is a perspective view illustrating the excreta recovery unit.

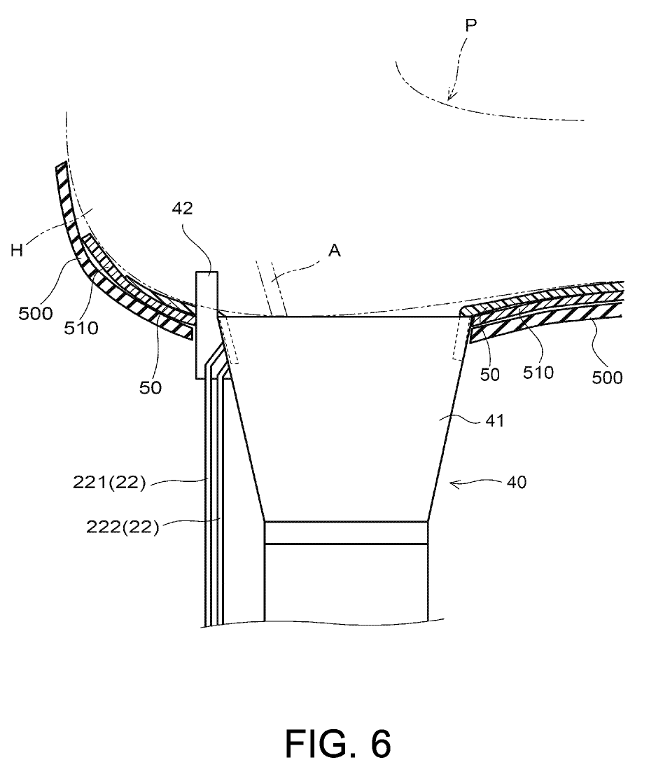

FIG. 6 is a schematic drawing illustrating the positional relationship between the user and the cup.

The cup 41 of the excreta recovery unit 40 has a funnel shape, and is constructed to receive excreta at an upper opening thereof and transfer the excreta to the recovery pipe 45, which is connected with a lower section of the cup 41. In this embodiment, a convex part 42 extended upward from an edge of the cup 41 is provided. When the user lies on his back on the mattress 30, the convex part 42 is inserted between the right and left buttocks H of the user P. In order to realize soft contact with the buttocks H, the tip part of the convex part 42 is provided to have a rounded shape.

Moreover, the edge of the cup 41 is joined with a circular opening edge of a sheet 50. The joining method may be welding or bonding. Moreover, the cup 41 and the sheet 50 may be molded as one piece. The sheet 50 is a sheet body made of silicone resin, for example, which is excellent in flexibility or texture and to which dirt hardly adheres. Although there is an idea that other plastics, latex rubber or the like is used as the material of the sheet 50, it is especially preferable to use silicone resin since some materials may possibly cause a problem such as causing an allergy reaction. Moreover, it is also preferable to make the cup 41 from silicone resin as with the sheet 50. It is to be noted that silicone resin, which is hydrophobic (lipophilic), normally causes excreta, which includes oil, to adhere and hardly flow. It is therefore preferable to reform the silicone resin on surfaces, which come into contact with excreta, of the cup 41 and the sheet 50 into hydrophilic resin by coating or the like.

As described above, the cup 41 is attached to the diaper cover 500 together with the sheet 50. The diaper cover 500 is formed of a plastic film having water resistance, for example. An opening to which the cup 41 is to be attached is provided at a substantially center of the diaper cover 500. Around the cup 41, a urine absorbing pad 510 is sandwiched at a gap between the sheet 50 and the diaper cover as illustrated in FIG. 6.

With such a structure, a state is formed wherein the cup 41 is set at the buttocks H when the user P wears the diaper cover. When the user P wearing the diaper cover 500 lies on his back on the mattress 30, the buttocks H of the user P is positioned just above the through hole 32h, so that the cup 41 is positioned in the through hole 32h. The recovery pipe 45 is provided below the cup 41, and reaches the excreta treatment unit 20 below the bed body 10 via the valve 451. The tip of the water supply hose 221 extended from the washing water tank 220 is put into the middle of the cup 41, and the tip of the air supply hose 222 is also put into the middle of the cup 41.

When the user P lies on his back on the mattress 30, the position of his buttocks H corresponds to the second section 32. Under these circumstances, the cup 41 fitted to the through hole 32h of the second section 32 is located below the anus A. Moreover, the convex part 42 of the cup 41 is put between the right and left buttocks H. This causes the right and left buttocks H to spread in accordance with the width of the convex part 42.

When the convex part 42 causes the right and left buttocks H to spread, excreta coming out of the anus A hardly adhere to the buttocks H. Moreover, since the right and left buttocks H are caused to spread, a wide cleaning area can be secured around the anus when washing water is jetted from the water supply hose 221 after excretion is finished, and it becomes easier to clean the anus A and the buttocks H around the anus A. When air or warm air is blown from the air supply hose 222 for drying, it also becomes easier to dry since the right and left buttocks H are caused to spread.

(Mattress)

Now, the first section 31 of the mattress 30 according to this embodiment will be described.

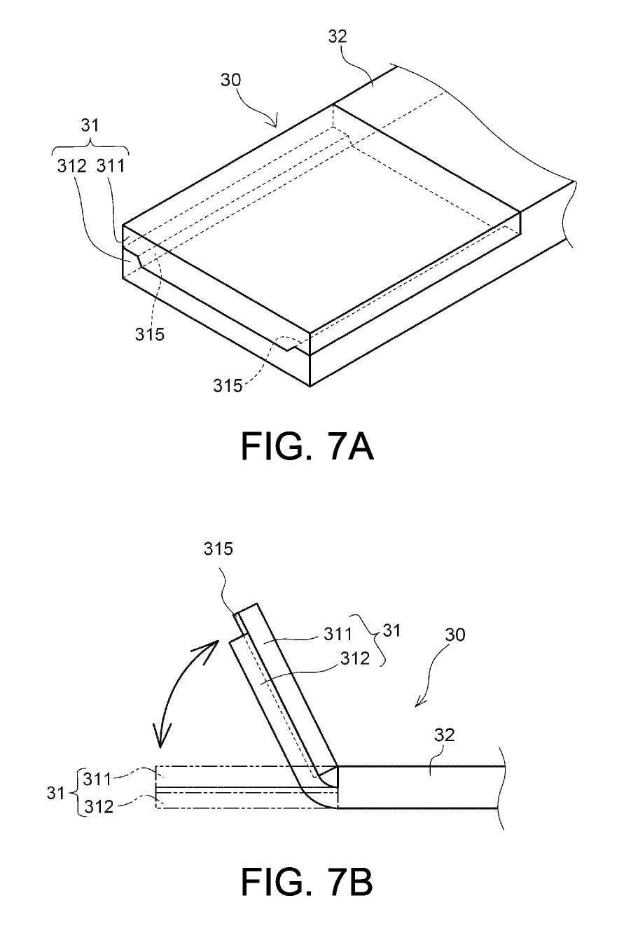

FIGS. 7A and 7B are schematic drawings illustrating the first section of the mattress.

FIG. 7A illustrates a perspective view of the first section 31, and FIG. 7B illustrates a side view of the first section 31.

The first section 31 of the mattress 30 is divided into an upper section 311 and a lower section 312, which are separated from each other. Moreover, a sliding mechanism 315 is provided between the upper section 311 and the lower section 312. The sliding mechanism 315 is constructed to slide the upper section 311 of the first section 31 in the longitudinal direction of the mattress 30 with respect to the lower section 312. In the example illustrated in FIG. 3, steps extended in the longitudinal direction of the mattress 30 are provided respectively at the right and the left, between the upper section 311 and the lower section 312. These steps function as the sliding mechanism 315.

In a state where the first section 31 of the mattress 30 is horizontal as illustrated in FIG. 7B, no deviation is generated between the upper section 311 and the lower section 312. On the other hand, when the first section 31 is raised and caused to tilt, the upper section 311, which becomes the inside of bending, slides with respect to the lower section 312, which becomes the outside of bending, so that the tip of the upper section 311 is extended.

An area of the mattress 30 between the first section 31 and the second section 32 is in contact with an area around the waist of the user. Therefore, if the sliding mechanism 315 is not provided, the curvature at the inside of the first section 31 becomes large (the curve becomes sharp) when the first section 31 of the mattress 30 is raised, and this may possibly press the area around the waist of the user P and give uncomfortable feeling of being sandwiched.

Since the sliding mechanism 315 is provided as described above, the upper section 311 of the first section 31 slides with respect to the lower section 312 when the first section 31 is raised so as to raise the back of the user P, and therefore it is possible to suppress sharpness in curve between the inside (upper section 311) of the first section 31 and the second section 32. This can eliminate the pressure to the area around the waist of the user P, and avoid uncomfortable feeling to the area around the waist when the back is raised.

(Excreta Treatment)

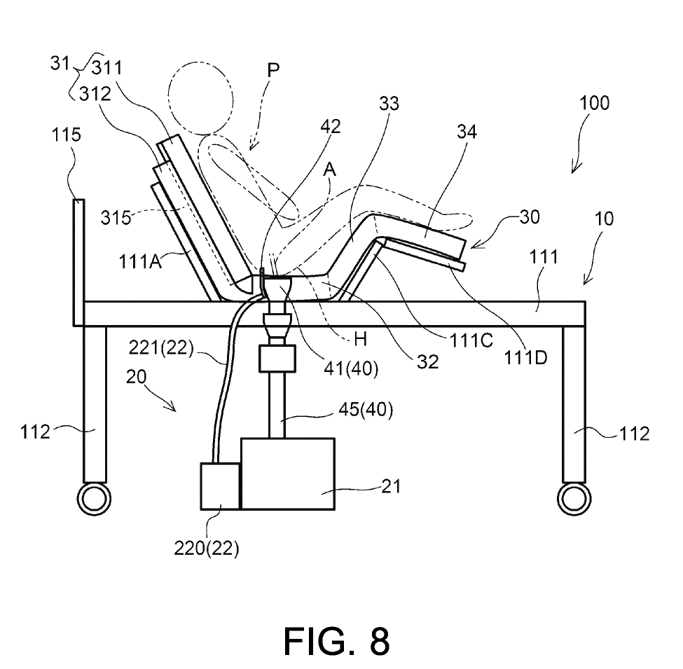

FIG. 8 is a schematic drawing illustrating excreta treatment.

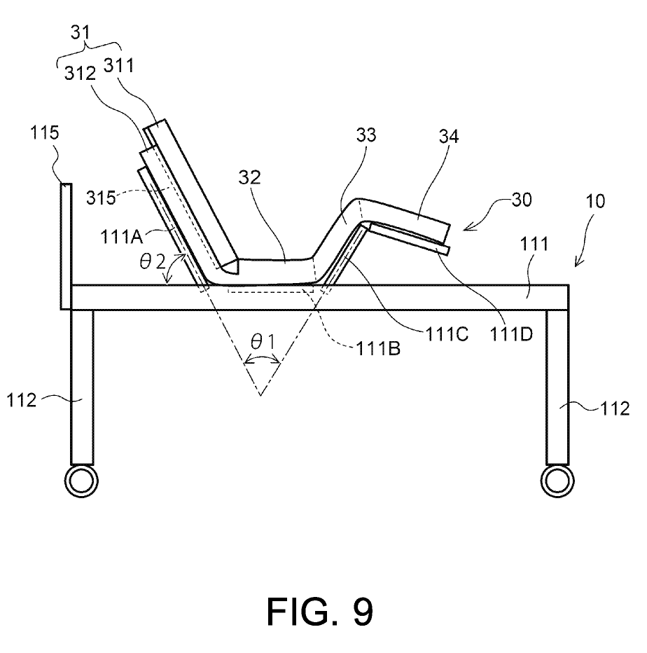

FIG. 9 is a schematic drawing illustrating the angle of the mattress.

Although it is possible to perform excreta treatment while the user P is lying on his back on a horizontal mattress 30, it is also possible to perform excreta treatment by raising the first section 31 of the mattress 30 so as to stand the back as illustrated in FIG. 8.

In a case where the first supporting section 111A is caused to tilt so as to raise the first section 31 of the mattress 30, it is preferable to set the angle θ1 of the third supporting section 111C with respect to the first supporting section 111A to be smaller than 90 degrees (acute angle) as illustrated in FIG. 9. Moreover, the angle θ2 of the first supporting section 111A with respect to the horizontal is set to be approximately 70 degrees. The fourth supporting section 111D is caused to tilt in conjunction with the third supporting section 111C so that the tips of toes descend. The second supporting section 111B is not caused to tilt.

The first section 31 of the mattress 30 stands and the back of the user P rises in accordance with the tilt of the first supporting section 111A, the third supporting section 111C and the fourth supporting section 111D. Moreover, the tilt of the third section 33 and the fourth section 34 of the mattress 30 forms a state where the knees of the user P are lifted.

Such an angle of the mattress 30 bends the waist of the user P at such an angle (acute angle) that the user P is sitting on a toilet seat. Since the waist bends at an acute angle, the anus is likely to spread, and the direction of the intestine extended to the anus becomes an angle with which it is easy to excrete. With the angle of the mattress 30 in this embodiment, it is easier for the user P to excrete than in a state where the user P is lying straight on his back.

Furthermore, the right and left buttocks H are caused to spread by the convex part 42 provided at the cup 41 in this embodiment. Accordingly, excreta hardly adhere to the buttocks H, and can be recovered reliably at the cup 41.

After excretion is finished, washing water is jetted from the water supply hose 221 of the cleaning unit 22 toward the buttocks H. In this process, cleaning is performed while keeping the angle of the mattress 30 close to the angle at the time of excretion. The buttocks H of the user P are thrusted downward (toward the cup 41 side) and, furthermore, the right and left buttocks H are kept in a state of being caused to spread by the convex part 42. Accordingly, cleaning can be performed by jetting washing water accurately toward the buttocks H or the anus A.

Moreover, since the buttocks H are thrusted downward, water which has been used for cleaning hardly goes to an area (the side of the back or the thighs) above the buttocks H. Water which has been used for cleaning drips from the buttocks H, which is the lowest part of the user P, and is recovered at the cup 41.

After cleaning with washing water is performed, air or warm air is blown from the air supply hose 222 as required. This can blow off the washing water and dry the buttocks H.

As described above, it becomes possible with this embodiment to provide a bed device 100, a mattress 30 and an excreta recovery unit 40, which can be located under a bed, can recover excreta easily and reliably, and are excellent in maintainability.

Although the above description has explained this embodiment and a variation thereof, it is to be noted that the present invention is not limited to these examples. For example, what is obtained by suitably adding or eliminating any component or changing design for each embodiment or variation thereof described above by those skilled in the art, or what is obtained by suitably combining features of the respective embodiments is also included in the scope of the present invention, as long as the subject matter of the present invention is provided therein.

### REFERENCE SIGNS LIST

10 Bed Body
11 Frame Part
12 Leg Part
20 Excreta Treatment Unit
21 Excreta Storage Unit
22 Cleaning Unit
30 Mattress
31 First Section
32 Second Section
32h Through Hole
33 Third Section
34 Fourth Section
40 Excreta Recovery Unit
41 Cup
42 Convex Part
45 Recovery Pipe
50 Sheet
100 Bed Device
111 Outer Frame
111A First Supporting Section
111B Second Supporting Section
111C Third Supporting Section
111D Fourth Supporting Section
111h Hole
115 Head Board
220 Washing Water Tank
221 Water Supply Hose
222 Air Supply Hose
311 Upper Section
312 Lower Section
315 Sliding Mechanism
451 Valve
452 Weight
500 Diaper Cover
510 Urine Absorbing Pad
A Anus
H Buttocks
P User

1. A bed device comprising:
a bed body having a frame part and a mattress laid on the frame part; and
an excreta treatment unit located below the mattress of the bed body,
wherein the mattress has:
a first section corresponding to a back;
a second section, which corresponds to buttocks and is provided with a through hole;
a third section corresponding to an above-knee region; and
a fourth section corresponding to a below-knee region,
the frame part has:
a first supporting section configured to support the first section and adjust an angle of the first section;
a second supporting section configured to support the second section;
a third supporting section configured to support the third section and adjust an angle of the third section; and
a fourth supporting section configured to support the fourth section and adjust an angle of the fourth section,
the excreta treatment unit has:
an excreta recovery unit, which is attached to the through hole;
an excreta storage unit configured to store excreta recovered at the excreta recovery unit; and
a cleaning unit, which is attached to the excreta recovery unit and jets washing water upward via the through hole, and
the excreta recovery unit has:
a cup fitted to the through hole;
a recovery pipe provided between the cup and the excreta storage unit; and
a convex part, which is provided to be extended upward from an edge of the cup and is inserted between right and left buttocks of a user.

2. The bed device according to claim 1, wherein an angle of the third supporting section with respect to the first supporting section becomes smaller than 90 degrees when the first supporting section and the third supporting section are caused to tilt.

3. A mattress to be laid on a frame part of a bed body, the mattress comprising:
a first section corresponding to a back;
a second section, which corresponds to buttocks and is provided with a through hole to which an excreta treatment device is to be attached;
a third section corresponding to an above-knee region; and
a fourth section corresponding to a below-knee region,
wherein the first section has:
a lower section;
an upper section provided separately from the lower section; and
a sliding mechanism configured to slide the upper section with respect to the lower section.

4. An excreta recovery device to be located below a mattress laid on a frame part of a bed body, the excreta recovery device comprising:
a cup to be fitted to a through hole provided at the mattress;
a recovery pipe connected with the cup; and
a convex part, which is provided to be extended upward from an edge of the cup and is inserted between right and left buttocks of a user.
